(19) United States
(12) Patent Application Publication
(10) Pub. No.: US 2016/0381566 A1
(43) Pub. Date: Dec. 29, 2016

(54) WI-FI OVER TV WHITE SPACE ADAPTER

(71) Applicant: Aviacomm Inc., Sunnyvale, CA (US)

(72) Inventors: Rishi Mohindra, Milpitas, CA (US); Shih Hsiung Mo, San Jose, CA (US); Chucai Zhou, San Jose, CA (US); William G. Xenakis, Pleasanton, CA (US)

(73) Assignee: Aviacomm Inc., Sunnyvale, CA (US)

(21) Appl. No.: 15/190,006

(22) Filed: Jun. 22, 2016

Related U.S. Application Data
(60) Provisional application No. 62/186,248, filed on Jun. 29, 2015.

(51) Int. Cl. H04W 16/14

(52) U.S. Cl. CPC H04W 16/14

(57) ABSTRACT

One embodiment of the present invention provides an apparatus for allowing a Wi-Fi module to operate over TV white space (TVWS) bands. The apparatus includes a first receiver coupled to a Wi-Fi module and configured to receive a Wi-Fi signal from the Wi-Fi module, an analog-to-digital conversion (ADC) module coupled to the first receiver and configured to convert the received Wi-Fi signal to the digital domain, a spectral-shaping module configured to reshape a spectrum of the converted digital Wi-Fi signal, a digital-to-analog conversion (DAC) module coupled to the spectral-shaping module, and a first transmitter coupled to the DAC module and configured to transmit signals in TV white space (TVWS) bands.

### RELATED APPLICATION

This application claims the benefit of U.S. Provisional Application No. 62/186,248, Attorney Docket Number AVC15-1002PSP, entitled “WI-FI OVER TV WHITE SPACE ADAPTER,” by inventors Shih Hsiung Mo, Chucai Zhou, and William G. Xenakis, filed 29 Jun. 2015.

### BACKGROUND

Field

The present disclosure relates generally to a Wi-Fi™ (registered trademark of Wi-Fi Alliance) adapter. More specifically, the present disclosure relates to an adapter that can allow commercially available Wi-Fi modems to operate over TV white space (TVWS) bands.

Related Art

The Federal Communications Commission (FCC) has allowed unlicensed broadcasting devices access to “white spaces” in the television spectrum, prompting the development of the “WhiteFi” technology, which may transform the way we purchase and use wireless Internet. The term “white space” typically refers to the unused broadcasting frequencies in the wireless spectrum, such as gaps between channels used for buffering purposes or parts of the spectrum that become free as a result of technical changes. In particular, the recent migration from analog to digital television frees up large areas between 54 MHz and 790 MHz. These unused spectrums can be used to deliver broadband Internet.

### SUMMARY

One embodiment of the present invention provides an apparatus for allowing a Wi-Fi module to operate over TV white space (TVWS) bands. The apparatus includes a first receiver coupled to a Wi-Fi module and configured to receive a Wi-Fi signal from the Wi-Fi module, an analog-to-digital conversion (ADC) module coupled to the first receiver and configured to convert the received Wi-Fi signal to the digital domain, a spectral-shaping module configured to reshape a spectrum of the converted digital Wi-Fi signal, a digital-to-analog conversion (DAC) module coupled to the spectral-shaping module, and a first transmitter coupled to the DAC module and configured to transmit signals in TV white space (TVWS) bands.

In a variation on this embodiment, the spectral-shaping module further includes at least a digital filter.

In a further embodiment, the digital filter is a finite impulse response (FIR) filter.

In a further embodiment, the spectral-shaping module further includes an upsampler.

In a variation on this embodiment, the apparatus further includes a sensor-and-switch module configured to: determine whether the Wi-Fi module is transmitting signals; and in response to determining that the Wi-Fi module is not transmitting signals, place the first receiver and the first transmitter in a sleep mode.

In a variation on this embodiment, the apparatus further includes a second receiver configured to receive signals in the TVWS bands and a second transmitter coupled to the second receiver and configured to transmit signals in Wi-Fi bands.

In a further variation, the apparatus further includes an automatic gain control (AGC) module, wherein the AGC module is configured to adjust an operating mode of the second transmitter based on a level of a signal received by the second receiver.

In a further variation, the AGC module is configured to place the second transmitter in a low gain mode in response to the level of the signal received by the second receiver exceeding a predetermined threshold, and place the second transmitter in a high gain mode in response to the level of the signal received by the second receiver being less than a predetermined threshold.

In a further variation, the AGC module is further configured to adjust an operating mode of the first transmitter based on a received signal strength indicator (RSSI) signal received from the Wi-Fi module.

In a variation on this embodiment, the apparatus further includes a phase shifter.

In a further variation, the phase shifter is an RF phase shifter configured to shift a phase of the received Wi-Fi signal, and the phase shifter is positioned between the Wi-Fi module and the first receiver.

In a further variation, the phase shifter is a cross multiplier configured to shift a phase of a baseband signal, and the phase shifter is positioned between the first receiver and the first transmitter.

In a further variation, the cross multiplier is a digital cross multiplier positioned between the ADC module and the DAC module.

### BRIEF DESCRIPTION OF THE FIGURES

FIG. 1A presents a diagram illustrating the spectral mask required by the FCC for mobile devices transmitting in the TV white spaces.

FIG. 1B presents a diagram illustrating the spectral mask required by IEEE Standard 802.11ac.

FIG. 2 illustrates the block diagram of an exemplary Wi-Fi over TVWS adapter, in accordance with an embodiment of the present invention.

FIG. 3 illustrates the block diagram of an exemplary Wi-Fi over TVWS adapter with analog filters, in accordance with an embodiment of the present invention.

FIG. 4A illustrates the block diagram of an exemplary Wi-Fi over TVWS adapter with a digital spectral-shaping module, in accordance with an embodiment of the present invention.

FIG. 4B illustrate the architecture of an exemplary digital spectral-shaping module, in accordance with an embodiment of the present invention.

FIG. 5A illustrates the block diagram of an exemplary Wi-Fi over TVWS adapter with automatic gain control, in accordance with an embodiment of the present invention.

FIG. 5B illustrates the block diagram of an exemplary Wi-Fi over TVWS adapter with automatic gain control, in accordance with an embodiment of the present invention.

FIG. 6A presents a diagram illustrating an exemplary analog beam forming implementation based on Wi-Fi over TVWS adapters with analog filters, in accordance with an embodiment of the present invention.

FIG. 6B presents a diagram illustrating an exemplary analog beam forming implementation based on Wi-Fi over TVWS adapters with analog filters, in accordance with an embodiment of the present invention.

FIG. 6C presents a diagram illustrating an exemplary analog phase shifter, in accordance with an embodiment of the present invention.

FIG. 6D presents a diagram illustrating an exemplary analog beam forming implementation based on Wi-Fi over TVWS adapters with a digital spectral-shaping module, in accordance with an embodiment of the present invention.

FIG. 7A presents a diagram illustrating an exemplary digital beam forming implementation based on Wi-Fi over TVWS adapters with a digital spectral-shaping module, in accordance with an embodiment of the present invention.

FIG. 7B presents a diagram illustrating an exemplary digital phase shifter, in accordance with an embodiment of the present invention.

FIG. 7C presents a diagram illustrating an exemplary digital beam forming implementation based on Wi-Fi over TVWS adapters with a digital spectral-shaping module, in accordance with an embodiment of the present invention.

FIG. 7D presents a diagram illustrating an exemplary beam forming implementation, in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

### Overview

Embodiments of the present invention provide a novel adapter that can allow current commercially available Wi-Fi modules to operate in TV white spaces (TVWS). More specifically, the adapter can convert standard 2.4 GHz or 5 GHz Wi-Fi signals to lower frequency signals within the TVWS. Because the TVWS standards typically have requirements that differ from Wi-Fi standards, the adapter can also include circuitry that can filter or shape the to-be-transmitted signals before transmission. In addition, the adapter can include a low-cost fast automatic gain control (AGC) module for adjusting the gains of the transmitter and the receiver. This adapter technology can also be used in the TVWS antenna array beam forming. More specifically, phase shifters can be added onto the adapters of different antenna channels, and beam forming can be accomplished by individually adjusting the amount of phase shift in each channel.

### Adapter Architecture

Although the FCC has opened up the TV white space spectrum for wireless mobile applications, a number of hurdles remain for consumer mobile devices to use these white spaces. For example, there are few commercially available RF components that operate in TVWS, thus making developing and manufacturing TVWS devices (e.g., mobile access points) expensive and time-consuming.

On the other hand, Wi-Fi technologies have been commercialized for several decades, and there are vast numbers of devices that are Wi-Fi ready, including but not limited to: personal computers, tablet computers, smartphones, video-game consoles, digital cameras, smart home appliances, etc. These Wi-Fi ready devices can connect to the Internet via a wireless access point (WAP). Given that most personal communication devices are Wi-Fi ready and there are many low-cost Wi-Fi modems available in the market, operating those existing Wi-Fi modules over the TVWS bands can provide many benefits. More particularly, unlike typical home Wi-Fi signals that can cover a range of a few tens of meters and can penetrate a few walls, TVWS signals can travel up to 10 kilometers and can penetrate vegetation, buildings, and other obstacles.

Typical Wi-Fi modules operate at 2.4 GHz or 5.0 GHz, whereas TVWS modules are required to operate in the VHF or UHF TV bands, with frequencies ranging between 54 MHz and 790 MHz and channel bandwidths of 6, 7, or 8 MHz. Hence, in order for Wi-Fi modules to operate over TVWS, the adapter needs to provide the frequency-conversion functionality. However, simply converting the signal frequency from the Wi-Fi bands to the TVWS bands is not sufficient, because TVWS standards have requirements different from Wi-Fi standards. One significant difference is that TVWS standards typically can have a more stringent transmission spectral mask requirement than Wi-Fi. For example, in the U.S., the FCC requires that emissions from the adjacent channels need to be at least 55 dB below the highest average power in the operating channel. On the other hand, a typical Wi-Fi standard (e.g., 802.11ac) requires that interference from adjacent channels only needs to be about 28 dB below.

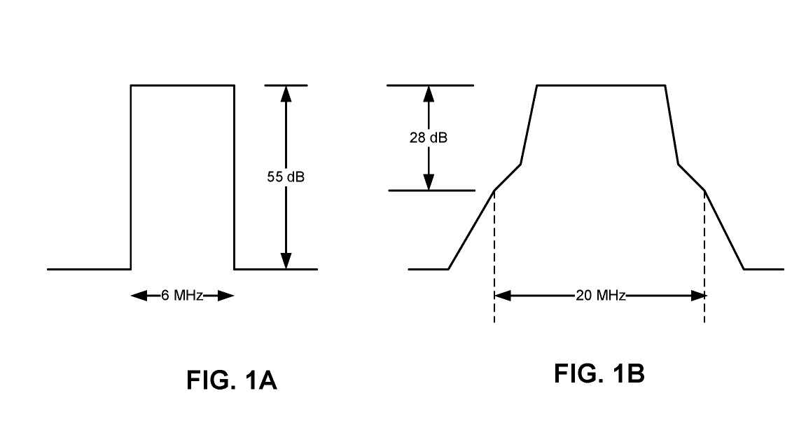

FIG. 1A presents a diagram illustrating the spectral mask required by the FCC for mobile devices transmitting in the TV white spaces. FIG. 1B presents a diagram illustrating the spectral mask required by IEEE Standard 802.11ac. As one can see from the figures, signals that meet the Wi-Fi spectral mask requirement may not be able to meet the TVWS spectral mask requirement due to the excessive side bands. Hence, in order for the Wi-Fi module to operate over the TVWS bands, the side bands of the Wi-Fi signals need to be suppressed.

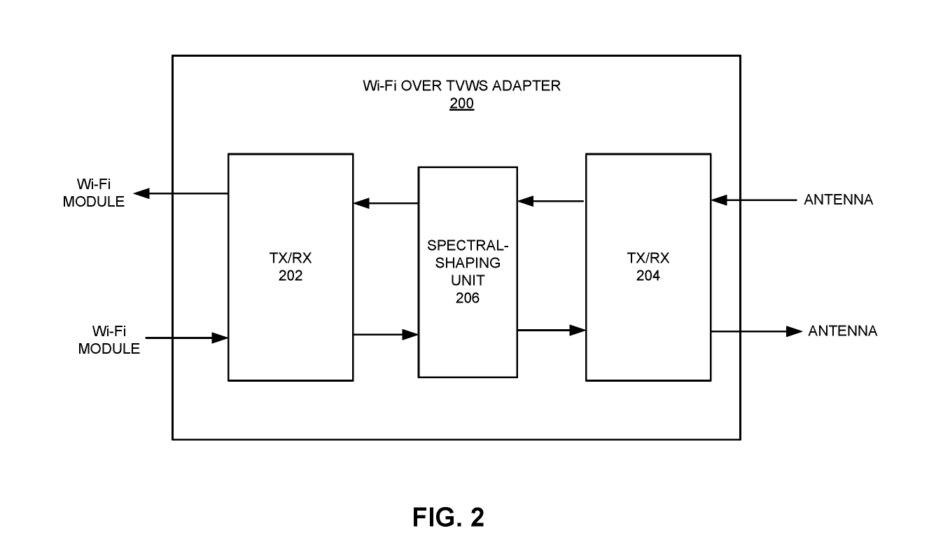

FIG. 2 illustrates the block diagram of an exemplary Wi-Fi over TVWS adapter, in accordance with an embodiment of the present invention. Wi-Fi over TVWS adapter 200 includes transceivers 202 and 204 and a spectral-shaping unit 206. Transceiver 202 is coupled to a conventional Wi-Fi module and can transmit/receive Wi-Fi signals to/from the Wi-Fi module. More specifically, in the receiving direction, transceiver 202 can receive the Wi-Fi signals and down-convert them to baseband; in the transmitting direction, transceiver 202 can up-convert baseband signals to the Wi-Fi bands. Transceiver 204 is coupled to the antenna and can transmit/receive TWVS signals. In the receiving direction, transceiver 204 can receive TVWS signals and down-convert them to baseband; in the transmitting direction, transceiver 204 can up-convert baseband signals to the TVWS bands. Spectral-shaping unit 206 is responsible for shaping the spectrum of the baseband signals to ensure that they can meet particular spectral mask and other regulatory requirements. In countries where the TVWS regulations are more relaxed such that signals complying with the Wi-Fi spectral mask can be accepted for transmission in the TVWS bands, spectral-shaping unit 206 can include simple analog filters. On the other hand, in countries (e.g., the U.S.) where a more demanding transmission spectral mask is required by government regulators, spectral-shaping unit 206 needs to include specially designed mask-shaping and RF compensation circuitries. More specifically, the mask-shaping and RF compensation are often performed in the digital domain.

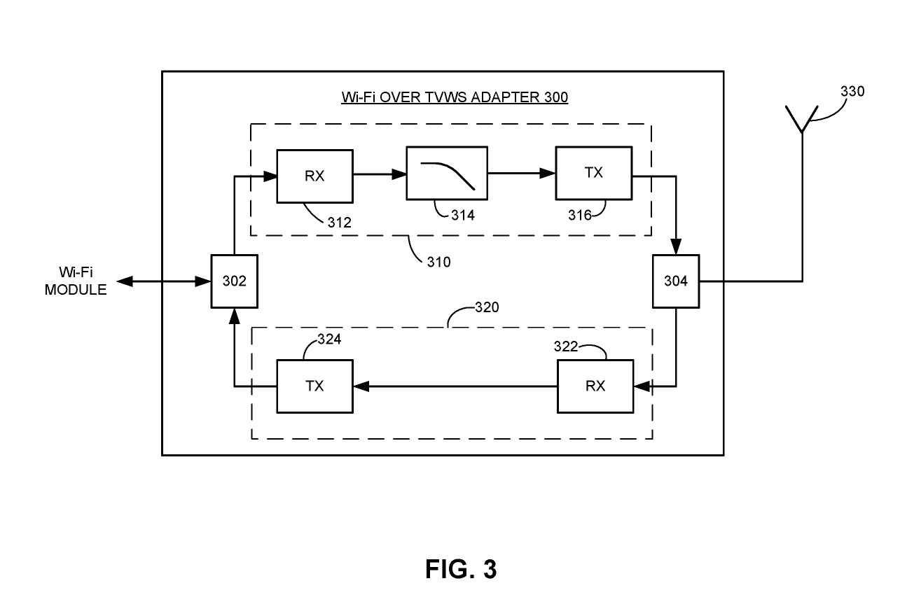

FIG. 3 illustrates the block diagram of an exemplary Wi-Fi over TVWS adapter with analog filters, in accordance with an embodiment of the present invention. Wi-Fi over TVWS adapter 300 includes a sensor-and-switch module 302, a switch module 304, a TVWS transmitting path 310, a TVWS receiving path 320, and an antenna 330. Note that, unlike Wi-Fi antennas that are designed to optimize transmission and receiving of Wi-Fi signals (e.g., 2.4 or 5 GHz RF signals), antenna 330 is specially designed to optimize transmission and receiving of TVWS signals (e.g., VHF or UHF TV signals).

Sensor-and-switch module 302 is coupled to the standard Wi-Fi module. In some embodiments, sensor-and-switch module 302 can be coupled to the output of the Wi-Fi transmitter. The sensor in sensor-and-switch module 302 can detect the existence of a signal sent from the Wi-Fi module and, if such signals exist, can control the switch in sensor-and-switch module 302 to connect the Wi-Fi module to transmitting path 310 and control switch 304 to connect transmitting path 310 to antenna 330. If the sensor in sensor-and-switch module 302 detects that there are no signals from the Wi-Fi module, it can control the switch in sensor-and-switch module 302 to connect the Wi-Fi module to receiving path 320 and control switch 304 to connect receiving path 320 to antenna 330.

Note that, although a standard Wi-Fi channel can have a bandwidth of 20, 40, or 80 GHz, in order to meet the TVWS standards where the channel bandwidth can be 6, 7, or 8 MHz (depending on the country), one can configure the Wi-Fi module to scale its channel bandwidth to fit the TVWS channel. For example, for a 20 MHz Wi-Fi module to operate over a 6 MHz TVWS channel, the 20 MHz channel bandwidth can be scaled by a factor of 4 to 5 MHz. This can sometimes be referred to as Wi-Fi/4 over TVWS.

Transmitting path 310 is responsible for receiving the Wi-Fi signals from the Wi-Fi module, converting the Wi-Fi signals to TVWS signals, and transmitting the TVWS signals via antenna 330. More specifically, transmitting path 310 includes a receiver module 312, an analog filtering module 314, and a transmitter module 316. Receiver module 312 can include any type of RF receiver that is capable of receiving the Wi-Fi signals. For example, if the Wi-Fi module transmits quadrature modulated signals, receiver module 312 can include a quadrature receiver, which can be a direct conversion (DC) or low intermediate-frequency (IF) receiver. The output of receiver module 312 (which can include the baseband or low-IF signals) can then be sent to analog filtering module 314, which can include one or more analog low-pass (LP) filters. Filtering module 314 can filter out any unwanted sideband or image frequencies of the baseband or low-IF signals. The filtered baseband or low-IF signals can then be sent to transmitter module 316, which up-converts the baseband or low-IF signals to the TVWS bands and transmits the TVWS signals via antenna 330.

Receiving path 320 is responsible for receiving the TVWS signals from antenna 330, converting the TVWS signals to Wi-Fi signals, and transmitting the Wi-Fi signals to the Wi-Fi module. More specifically, receiving path 320 includes a receiver module 322 and a transmitter module 324. Receiver module 322 can include any type of RF receiver that is capable of receiving the TVWS signals. Similar to receiver module 312, receiver module 322 receives and converts the TVWS signals to low-IF or baseband. Because the TVWS receiver channel selectivity requirement is similar to that of Wi-Fi standards, there is no need for additional filtering. The output of receiver module 322 can then be sent directly to transmitter module 324, which up-converts the baseband or low-IF signals to the 2.4 or 5 GHz Wi-Fi signals and transmits the Wi-Fi signals to the Wi-Fi module.

The simple analog filtering performed by adapter 300 cannot meet the more stringent transmission spectral mask requirements of some government regulators and the higher performance requirements of the customers. To do so, mask shaping and RF compensation will be needed to ensure that the spectrum of the transmitted TVWS signals can meet the regulatory requirement without distortions and errors. In some embodiments, these operations are performed in the digital domain.

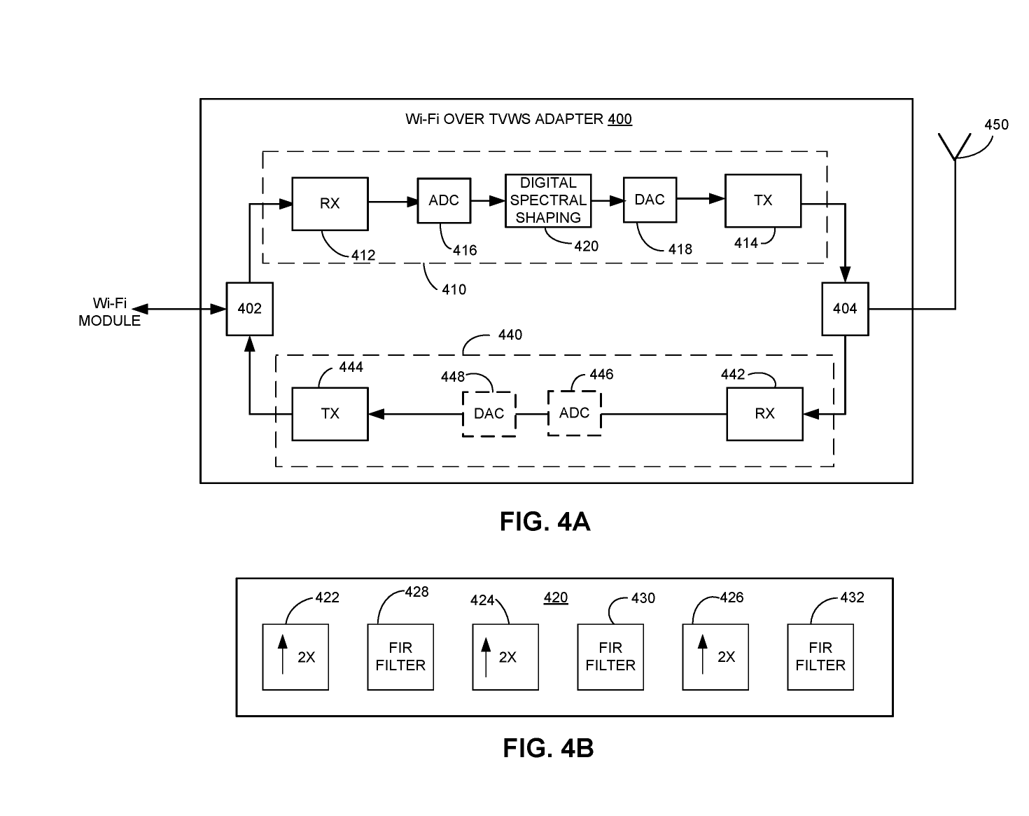

FIG. 4A illustrates the block diagram of an exemplary Wi-Fi over TVWS adapter with a digital spectral-shaping module, in accordance with an embodiment of the present invention. Similar to adapter 300, Wi-Fi over TVWS adapter 400 includes a sensor-and-switch module 402, a switch module 404, a TVWS transmitting path 410, a TVWS receiving path 440, and an antenna 450.

Sensor-and-switch module 402 and switch module 404 are similar to sensor-and-switch module 302 and switch module 304, respectively. They are responsible for activating the appropriate TVWS transmitting or receiving path in response to the existence or absence of signals sent from the Wi-Fi module. In some embodiments, the control signal for the transmit/receive mode of operation for switch modules 402 and 404 can be taken from the Wi-Fi module's control signal for the transmit/receive mode of operation. For example, if the Wi-Fi module is operating in the transmit mode, its transmit-mode-selection control signal can be used to control switch modules 402 and 404 to place Wi-Fi over TVWS adapter in transmit mode.

TVWS transmitting path 410 includes a receiver module 412, a transmitter module 414, an analog-to-digital converter (ADC) 416, a digital-to-analog converter (DAC) 418, and a digital spectral-shaping module 420. Receiver module 412 and transmitter module 414 are similar to receiver module 312 and transmitter module 316, respectively. More specifically, receiver module 412 is responsible for receiving Wi-Fi signals from the Wi-Fi module and transmitter module 414 is responsible for transmitting TVWS signals via antenna 450.

ADC 416 is responsible for converting the output of receiver module 412, which can include analog baseband or low-IF signals, to digital domain. The converted digital signals can then be sent to digital spectral-shaping module 420, which can perform various digital signal-processing operations to shape the spectrum of the digital baseband or low-IF signals to ensure that they can meet the TVWS spectral mask and other regulatory requirements.

DAC 418 is responsible for converting the output of digital spectral-shaping module 420 back to the analog domain and sending the baseband or low-IF analog signals with a cleaner spectrum to transmitter module 414 for transmission in the TVWS bands.

TVWS receiving path 440 can be similar to TVWS receiving path 320 and can simply include a receiver module 442 (which is similar to receiver module 322) and a transmitter module 444 (which is similar to transmitter module 324). TVWS receiving path 440 can also optionally include an ADC 446 and a DAC 448. In further embodiments, TVWS receiving path 440 can optionally include a digital processing module between ADC 446 and DAC 448.

FIG. 4B presents a diagram illustrating the exemplary architecture of a digital spectral-shaping module, in accordance with an embodiment of the present invention. Digital spectral-shaping module 420 can include a number of upsamplers (such as upsamplers 422, 424, and 426) and a number of finite impulse response (FIR) filters (such as FIR filters 428, 430, and 432). More specifically, each upsampler is followed by an FIR filter to form a chain of upsampling and filtering. The upsampling and filtering can significantly improve the adjacent channel leakage ratio (ACLR) of the to-be-transmitted signals to ensure that the transmitted TVWS signals can meet the spectral mask requirement. The distributed design (e.g., three cascaded stages of upsampling and filtering) can reduce the overall computation cost.

In addition to digital filtering, various RF distortion compensation schemes can also be implemented in Wi-Fi over TVWS adapter 400 to compensate for errors (e.g., carrier leakage and I/Q imbalance) that may be introduced by the Wi-Fi module as well as by receiver module 412. The RF compensation circuitry can be part of receiver module 412 and is not shown in FIGS. 4A and 4B.

Like Wi-Fi devices (e.g., Wi-Fi APs and Wi-Fi clients) that are facing the near-far problem, TVWS devices may face the same problem and require automatic gain control (AGC). This is because APs need to communicate with clients that may be near or far, causing a huge variation in received signal levels. Clients, on the other hand, may also face the near-far problem, because they are subject to signals from not only the AP, but other clients in the neighborhood.

For TVWS devices that use the Wi-Fi over TVWS adapter for transmission and receiving, one way to resolve the near-far problem is to extend the built-in AGC functionality of the Wi-Fi module to the adapter. However, this solution can lead to additional computation at the Wi-Fi module and complicated wiring between the Wi-Fi module and the adapter. To reduce cost, it is desirable to implement AGC on the adapter itself.

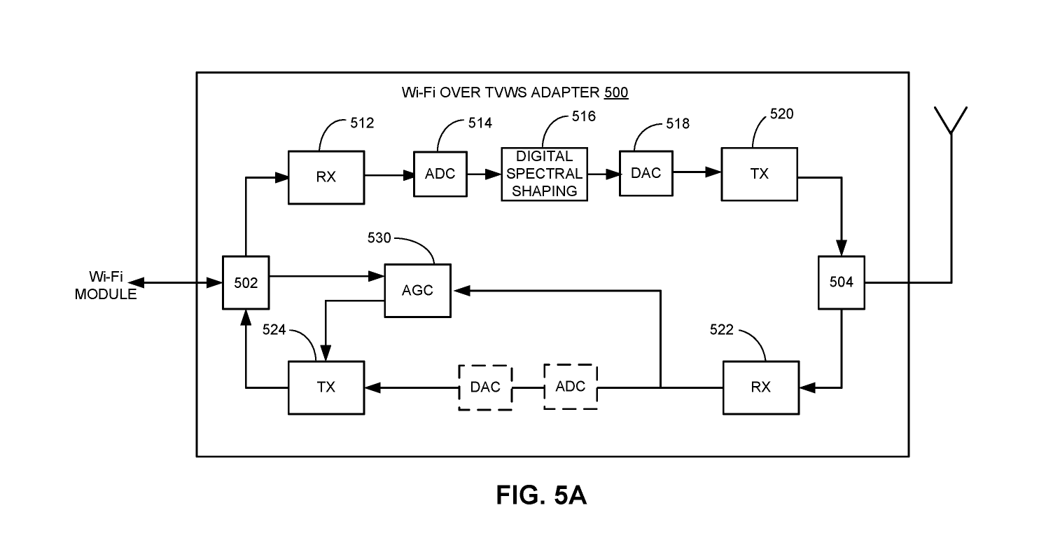

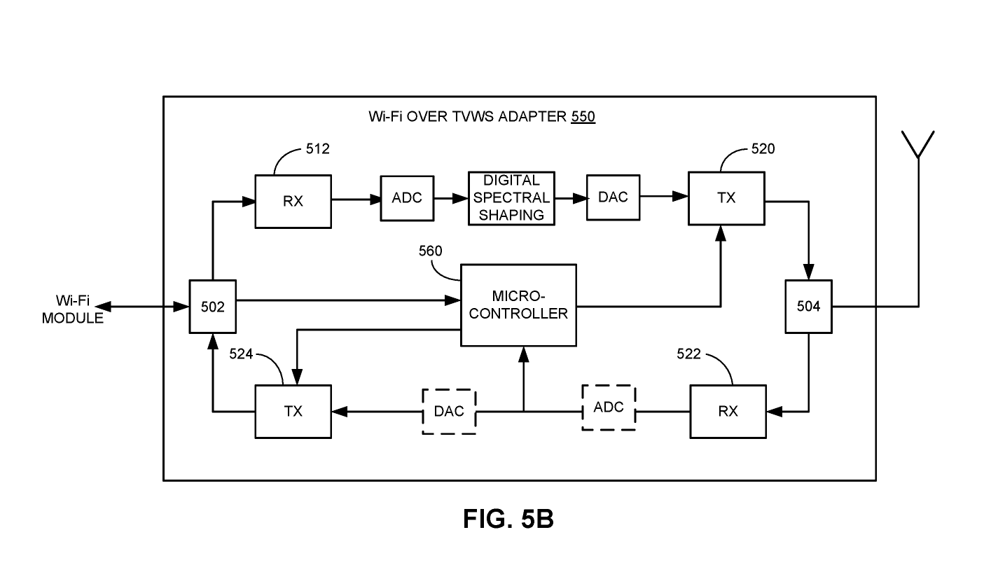

FIG. 5A illustrates the block diagram of an exemplary Wi-Fi over TVWS adapter with automatic gain control, in accordance with an embodiment of the present invention. Wi-Fi over TVWS adapter 500 is similar to adapter 400 and can include sensor-and-switch module 502, a switch module 504, a Wi-Fi receiver module 512, an ADC module 514, a digital spectral-shaping module 516, a DAC module 518, a TVWS transmitter module 520, a TVWS receiver module 522, a Wi-Fi transmitter module 524, and optional ADC and DAC modules between TVWS receiver module 522 and Wi-Fi transmitter module 524. In addition, Wi-Fi over TVWS adapter 500 includes an AGC module 530 for controlling the gain of TVWS transmitter module 520.

Note that AGC on TVWS transmitter module 520 can be essential. For a low-cost solution, Wi-Fi over TVWS adapter 500 may have a limited dynamic range in its receiving path, such as about 20 dB. For example, the adapter's gain can be set at the sensitivity level (e.g., −70 dBm) for the highest data rate (e.g., using 64 QAM for 3GPP Release 5 and 6) with an acceptable noise figure. If the signal level drops below the sensitivity level, the data rate can be reduced using a more robust modulation (e.g., BPSK). If the signal level increases by at least 20 dB (e.g., to a power level of −50 dBm), the receiving path of the adapter can start to saturate or compress, leading to degradation in the signal error vector magnitude (EVM). To solve this problem, the gain of the receiving path can be reduced before the compressing stage (e.g., before the power amplifier inside transmitter module 524) in the event of receiving a higher level input signal.

In some embodiments, AGC module 530 can include a level detector which detects the baseband signal level outputted by receiver module 522. For example, it can work as a cheap received signal strength indicator (RSSI) module with a 12% peak error for single tune signals. The peak error can be much less for multi-tone signals (e.g., OFDM signals). The power amplifier in transmitter module 524 can be configured to operate in two modes, a high gain mode and a lower gain mode. In some embodiments, AGC module 530 can control the operation of the PA in transmitter module 524 based on the RSSI. If the RSSI is greater than a predetermined threshold, AGC module 530 places the PA into the low gain mode, which can have a 20 dB attenuation compared to the high gain mode.

In some embodiments, AGC module 530 can also be coupled to sensor-and-switch module 502 to receive the switch signal from sensor-and-switch module 502. As discussed previously, sensor-and-switch module 502 detects the existence of Wi-Fi signals from the Wi-Fi module and, in response, turns on the transmitting path (which can include receiver module 512 and transmitter module 520). Note that the default setting for the transmitting path (particularly transmitter module 520) is off, whereas the default setting for the receiving path (particularly transmitter module 524) is on. In some embodiments, the receiving path can be switched off when the transmitting path is switched on. In addition, AGC module 530 can be configured to reset the PA in transmitter module 524 to the high gain mode every time the transmitting path is switched on.

FIG. 5B illustrated the block diagram of an exemplary Wi-Fi over TVWS adapter with automatic gain control, in accordance with an embodiment of the present invention. Wi-Fi over TVWS adapter 550 is similar to adapter 500 except that, instead of an AGC module, Wi-Fi over TVWS adapter 550 includes a microcontroller 560, which can be used to set amplifier gains using a digital control. More specifically, microcontroller 560 can monitor the received signal strength (e.g., by monitoring the output of an ADC) and control the gain mode of the PA via a digital output (e.g., a pin or an SPI register). For example, in response to the signal level of the ADC output exceeding a threshold, micro-controller 560 can place the PA in transmitter module 524 in a low gain mode. On the other hand, in response to the signal level of the ADC output being less than the threshold, microcontroller 560 can place the PA in transmitter module 524 in the high gain mode. In addition, microcontroller 560 can also reset the gains in a way similar to AGC module 530. More specifically, microcontroller 560 can receive the switching signal from sensor-and switch module 502, and can reset the PA in transmitter module 524 to the high gain mode every time the transmitting path is switched on (or the receiving path is switched off).

To prevent the adapter's AGC from affecting the AGC algorithm run by the Wi-Fi module, the attack time, which is the time to detect the receiving power plus the gain-reduction response time, needs to be less than 1 microsecond for a 5 MHz channel. For a 20 MHz channel, the attack time needs to be less than 250 ns. In some embodiments, the system limits the attack time to less than 200 ns.

In some embodiments, a time-out period can be introduced before the PA of the transmitter is placed in the high gain mode. For example, a PA can return to the high gain mode after the received signal level is below a predetermined threshold for a predetermined time (e.g., 200 ns). Similarly, the PA can return to the high gain mode after the receiving path has been switched off for a predetermined time.

In addition to gain control over transmitter module 524, microcontroller 560 can also control the gains of transmitter module 520 to ensure that the TVWS client can receive TVWS signals at a consistent power level. In some embodiments, this gain control is achieved using closed-loop power control with RSSI feedback from the AP to the client. More specifically, the Wi-Fi module's software can be modified such that the RSSI information can be sent to microcontroller 560, which can in turn adjust the gain of transmitter module 520 according to the RSSI. This is a robust method in overcoming link variations over time. Although it is possible to adjust the uplink transmission power during client installation, such a solution can be prone to link variations.

### Wi-Fi Over TVWS Adapter for Antenna Array Beam Forming

Beam forming is a signal processing technique used to control the directionality of the transmission and reception of radio signals. More specifically, by carefully controlling the phase of the signal transmitted from multiple antennas, signals at the desired direction experience constructive interference while others experience destructive interference. For Wi-Fi standards that implement multiple-input multiple-output (MIMO) technologies, such as 802.11n and 802.11ac, beam forming can significantly improve the performance, reliability, range, and coverage of the wireless network. Similarly, beam forming can improve the performance of the Wi-Fi over TVWS system.

To achieve beam forming in the Wi-Fi over TVWS system, one needs to replace the single TVWS antenna with an antenna array having multiple antenna array elements (e.g., 4 antennas). Each antenna can be coupled to a dedicated receiving/transmitting chain that includes amplifiers and up/down converters. A phase shifter can be introduced in each signal path in order to individually control the phase of each signal path.

It can be shown that the directivity of a linear antenna array with equal spacing between adjacent elements is maximum along the array normal direction, i.e., a direction that is normal to the antenna plane. It can also be shown that, for such a linear antenna array, beam steering by an angle θ can be achieved by incrementally shifting the phase of each antenna element signal path by an

$$angle φ = \frac{2 π d \cdot sin ( θ )}{λ} ,$$

where d is the distance between adjacent antenna elements, and λ is the RF wavelength. To maximize the gain, one can place multiple (e.g., 4 or 8) antenna elements into a linear array with a λ/2 spacing between adjacent elements.

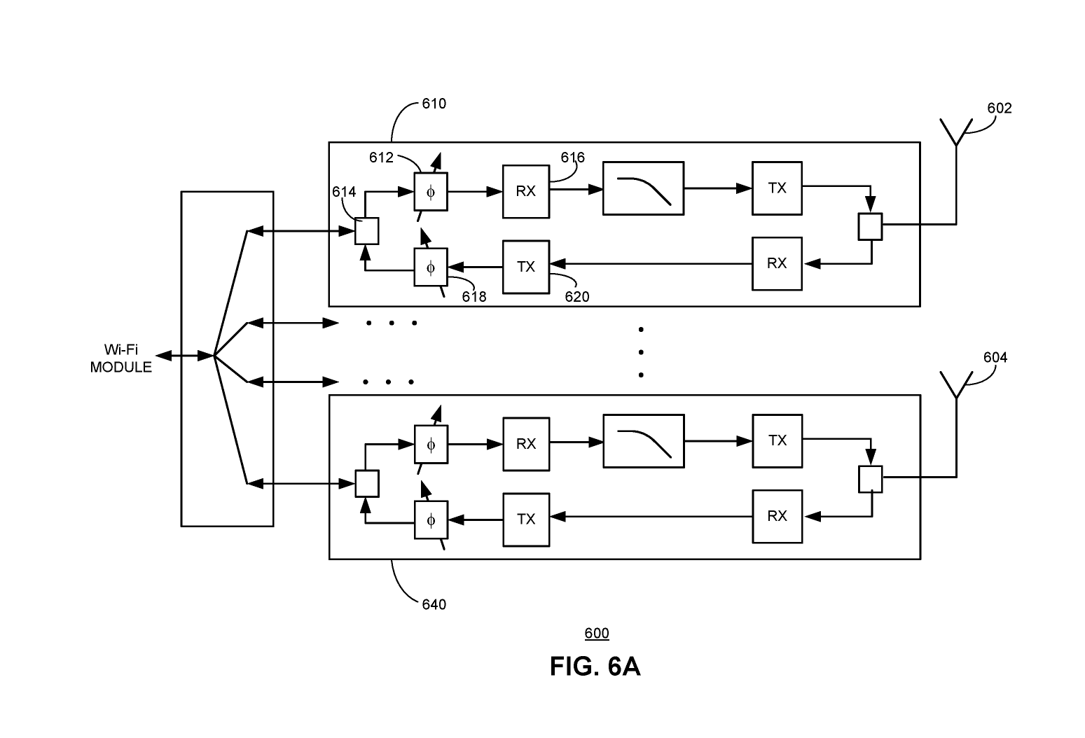

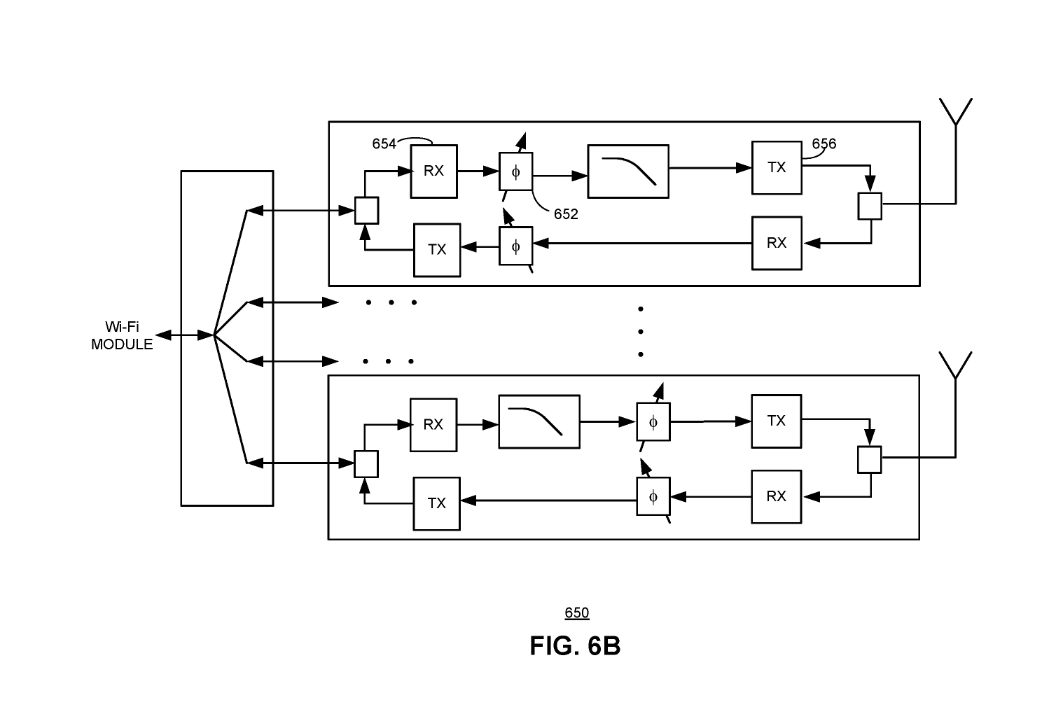

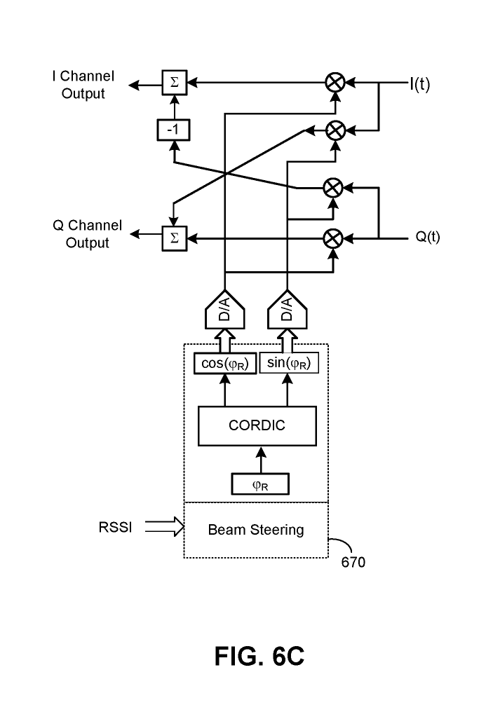

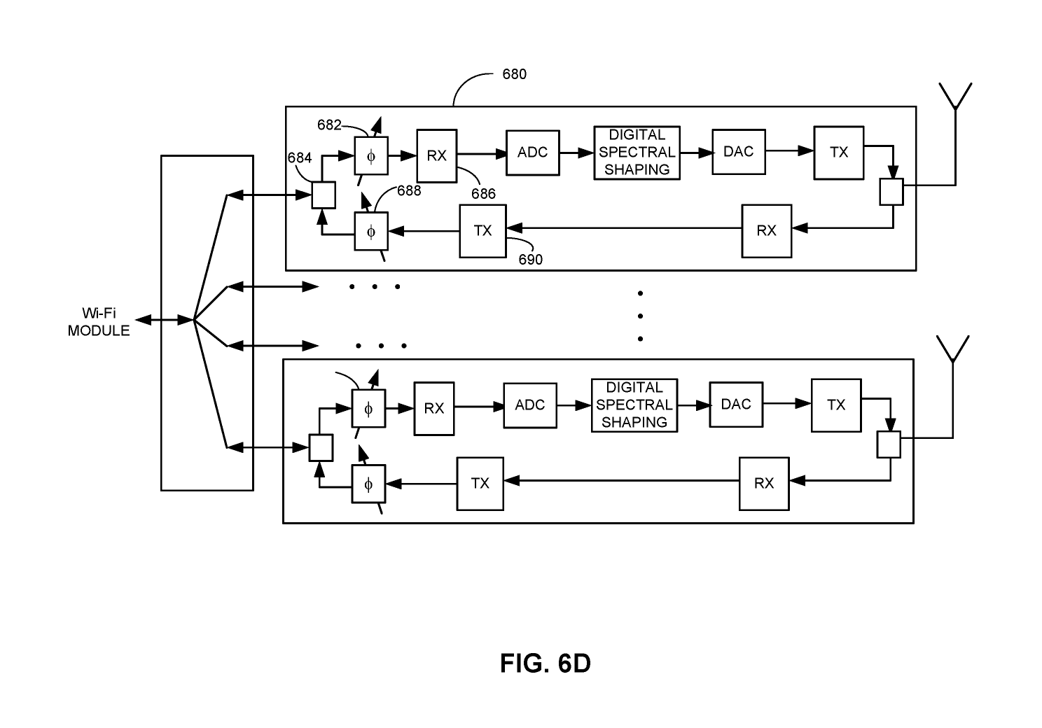

In some embodiments, analog phase shifters can be used to incrementally shift the phase of each signal path. For Wi-Fi over TVWS applications, the analog phase shifters can be part of the Wi-Fi over TVWS adapter. FIG. 6A presents a diagram illustrating an exemplary analog beam forming implementation based on Wi-Fi over TVWS adapters with analog filters, in accordance with an embodiment of the present invention.

In FIG. 6A, Wi-Fi over TVWS system 600 includes multiple antennas coupled to a Wi-Fi module via multiple Wi-Fi over TVWS adapters. For example, antenna 602 is coupled to the Wi-Fi module via Wi-Fi over TVWS adapter 610, and antenna 604 is coupled to the Wi-Fi module via Wi-Fi over TVWS adapter 640. In some embodiments, system 600 can include 4 or 8 antennas, forming a linear antenna array having 4 or 8 antenna elements.

The Wi-Fi over TVWS adapters (e.g., adapter 610) included in system 600 can be similar to Wi-Fi over TVWS adapter 300 shown in FIG. 3, except that each of the transmitting and receiving paths now includes a phase shifter. For example, phase shifter 612 is inserted in the transmitting path of Wi-Fi over TVWS 610, positioned between sensor-and-switch module 614 and Wi-Fi receiver module 616. Similarly, phase shifter 618 is inserted in the receiving path, positioned between sensor-and-switch module 614 and Wi-Fi transmitter module 620. The phase shifters are analog phase shifters and can be configured to shift the phase of the RF analog signals.

In some embodiments, the analog shifters can include phase shifters implemented using application-specific integrated-circuit (ASIC) chips. For example, a vector modulator based on an IQ modulator with a programmable vector can provide independent adjustment of both phase and amplitude.

In addition to the example shown in FIG. 6A, where phase shifting is performed on the RF signals, it is also possible to apply phase shifting to the baseband signals. FIG. 6B presents a diagram illustrating an exemplary analog beam forming implementation based on Wi-Fi over TVWS adapters with analog filters, in accordance with an embodiment of the present invention.

Wi-Fi over TVWS system 650 is similar to Wi-Fi over TVWS system 600, except that the phase shifter in the transmitting or receiving path of each Wi-Fi over TVWS adapter is inserted between the transmitter and receiver modules. For example, phase shifter 652 is positioned between Wi-Fi receiver module 654 and TVWS transmitter module 656. In other words, phase shifting happens after down-conversion and before up-conversion.

In some embodiments, phase shifter 652 can include a complex multiplier, which can perform the complex multiplication [I(t)+jQ(t)]·[cos(φ)+j·sin(φ)], where I(t) and Q(t) are the in-phase and quadrature components of the baseband signal. In further embodiments, the sine and cosine of the phase angles used for the complex multiplication can be generated using the CORDIC algorithm (also known as the Volder's algorithm) in rotation mode, where a vector v₀=1+i0 is rotated by the desired phase angle, and the resultant X and Y outputs can then be used as cosine and sine values after a fixed scaling corresponding to the number of iterations (or stages) used in the CORDIC algorithm. In addition to the CORDIC algorithm, it is also possible to use a look up table to obtain the sin and cosine values for phase angles ranging between −π and π.

FIG. 6C presents a diagram illustrating an exemplary analog phase shifter, in accordance with an embodiment of the present invention. As one can see from FIG. 6C, to shift a baseband signal by a desired phase angle φ_{R}, the sin and cosine of φ_{R} generated by the CORDIC module are cross multiplied with the I and Q components of the baseband signal and the multiplication results are summed to obtain the I and Q channel output of the phase shifting result.

FIG. 6C also shows that the beam-steering digital-logic block 670 receives the RSSI (either from the local node or from the remote node) feedback and can use this information to calibrate the phase angle.

In addition to being implemented in the analog Wi-Fi over TVWS adapter (e.g., the adapter using analog filters), the analog phase shifter can also be implemented in a digital Wi-Fi over TVWS adapter. FIG. 6D presents a diagram illustrating an exemplary analog beam forming implementation based on Wi-Fi over TVWS adapters with a digital spectral-shaping module, in accordance with an embodiment of the present invention. In FIG. 6D, the Wi-Fi over analog TVWS adapter on an antenna signal path can include a digital spectral-shaping module in the transmitting path. In addition, an RF analog phase shifter can be inserted before a receiver module. For example, in the transmitting path of Wi-Fi over analog TVWS adapter 680, an RF phase shifter 682 is placed between sensor-and-switch module 684 and Wi-Fi receiver module 686. On the other hand, in the receiving path, an RF phase shifter 688 is placed between sensor-and-switch module 684 and Wi-Fi transmitter module 690.

Although analog phase shifting can be used for beam forming, digital beam forming can provide additional benefits, such as faster control and more precise phase shifting. Digital beam forming can be readily implemented on the digital Wi-Fi over analog TVWS adapter, which already converts the baseband signal to the digital domain for digital spectral shaping.

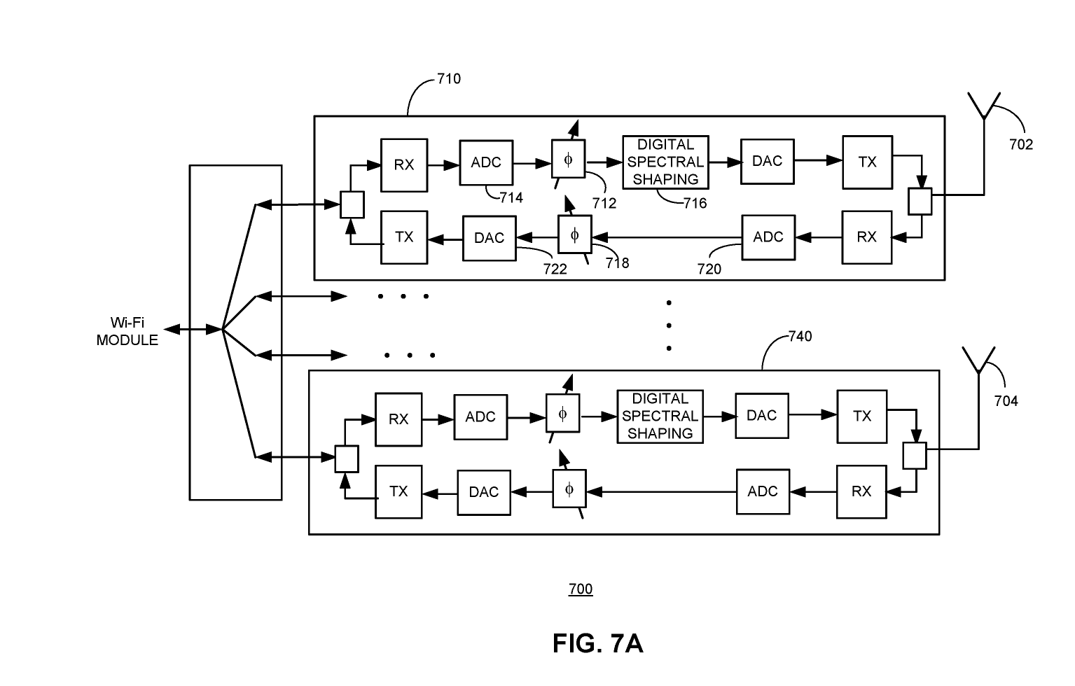

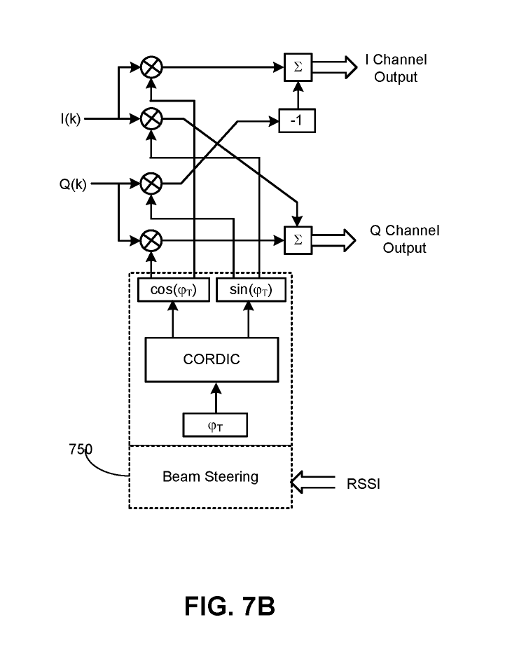

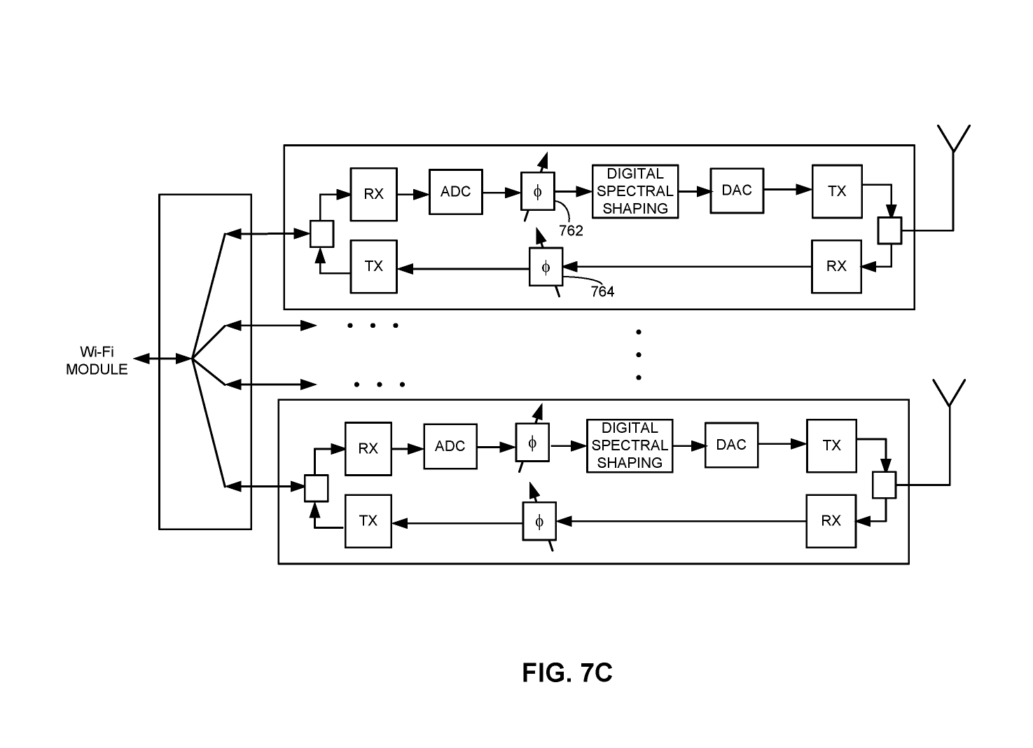

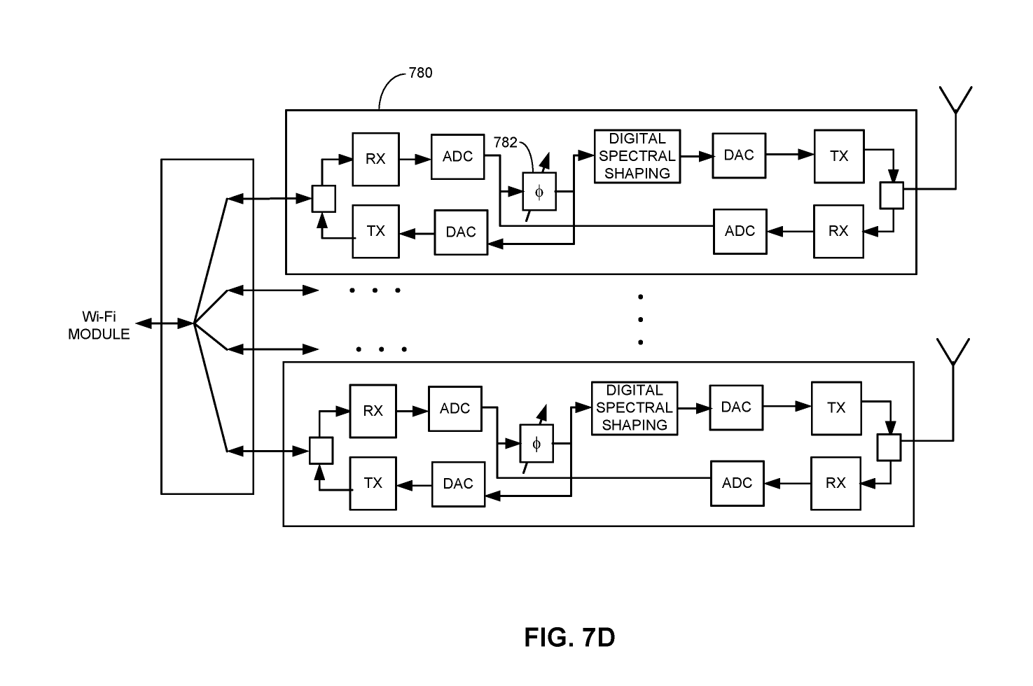

FIG. 7A presents a diagram illustrating an exemplary digital beam forming implementation based on Wi-Fi over TVWS adapters with a digital spectral-shaping module, in accordance with an embodiment of the present invention. In FIG. 7A, Wi-Fi over TVWS system 700 includes multiple antennas coupled to a Wi-Fi module via multiple Wi-Fi over TVWS adapters. For example, antenna 702 is coupled to the Wi-Fi module via Wi-Fi over TVWS adapter 710, and antenna 704 is coupled to the Wi-Fi module via Wi-Fi over TVWS adapter 740. In some embodiments, system 700 can include 4 or 8 antennas, forming a linear antenna array having 4 or 8 antenna elements.

The Wi-Fi over TVWS adapters (e.g., adapter 710) included in system 700 can be similar to Wi-Fi over TVWS adapter 400 shown in FIG. 4A, except that each of the transmitting and receiving paths now includes a digital phase shifter. For example, digital phase shifter 712 is inserted in the transmitting path of Wi-Fi over TVWS, between ADC module 714 and digital spectral-shaping module 716. Similarly, in the receiving path, digital phase shifter 718 is inserted between ADC module 720 and DAC module 722. These digital phase shifters can be configured to shift the phase of the digital baseband signals.

In some embodiments, a digital phase shifter (e.g., digital phase shifter 712) can include a digital complex multiplier. In further embodiments, the digital phase shifter can include a CORDIC module configured to generate the sine and cosine values of a phase angle using the CORDIC algorithm in rotation mode. FIG. 7B presents a diagram illustrating an exemplary digital phase shifter, in accordance with an embodiment of the present invention. As one can see from FIG. 7B, the schematic of the digital phase shifter is similar to that of the analog phase shifter shown in FIG. 6C, except that the digital phase shifter receives digital I and Q signals, which are cross multiplied with the sin and cosine values (also in the digital format) of the phase angle. The digital phase shifter requires no AD conversion, and everything is done in the digital domain. Therefore, the digital beam forming can provide a faster response, which is an important factor for adaptive beam forming.

In FIG. 7B, the digital phase shifter can also include a controller 750, which can compute the amount of phase shift based on the RSSI. If the phase shifter is part of the transmitting path, the RSSI is received from the opposite node link of the link. If the phase shifter is part of the receiving path, the RSSI is the local RSSI.

Because the ADC and DAC modules in the receiving path of a Wi-Fi over TVWS adapter are optional, it may be more practical to have a hybrid solution, where the transmitting path implements a digital phase shifter and the receiving path implements an analog phase shifter. FIG. 7C presents a diagram illustrating an exemplary digital beam forming implementation based on Wi-Fi over TVWS adapters with a digital spectral-shaping module, in accordance with an embodiment of the present invention.

In FIG. 7C, the transmitting path of a Wi-Fi over TVWS adapter can be the same as that of Wi-Fi over TVWS adapter 710 shown in FIG. 7A. More specifically, a digital phase shifter (e.g., phase shifter 762) can be inserted between the ADC and DAC modules in the transmitting path. In the receiving path, there is neither an ADC nor a DAC, and an analog phase shifter (e.g., phase shifter 764) can be inserted between the TVWS receiving module and the Wi-Fi transmitting module. Both phase shifters can be based on a cross multiplier. The analog phase shifter can be similar to the one shown in FIG. 6C, and the digital phase shifter can be similar to the one shown in FIG. 7B.

The Wi-Fi over TVWS system is a half duplex system, meaning that only one of the transmitting and receiving paths remains active. This makes it possible for the transmitting and receiving paths of a Wi-Fi over TVWS adapter to share a single phase shifter, thus reducing the device cost. FIG. 7D presents a diagram illustrating an exemplary beam forming implementation, in accordance with an embodiment of the present invention. In FIG. 7D, each Wi-Fi over TVWS adapter includes a single phase shifter that can be shared between its transmitting and receiving paths. For example, Wi-Fi over TVWS adapter 780 includes a single digital phase shifter 782, which is shared between the transmitting path and the receiving path.

As discussed previously, the Wi-Fi over TVWS adapter can be configured to switch off its transmitting chain or place the transmitting chain in sleep mode, in response to detecting that the Wi-Fi module is not transmitting signals. However, each time the transmitting chain is switched off, any phase calibration result for beam steering may be lost, and the system needs to recalibrate when the transmitting chain is turned back on. To solve this problem, in some embodiments, the system can keep all frequency generation components (e.g., local oscillators and synthesizers) and associated phase-locked loops (PLLs) and dividers on constantly, regardless of whether the transmitting chain is turned off or in sleep mode. This way, the system can preserve the initial phase calibration result of the beam steering.

In general, TVWS beam forming can provide many advantages, regardless of the particular scheme being used. Placing the phase shifter on the Wi-Fi over TVWS adapter to allow for beam forming can significantly reduce the required PA power (e.g., by more than four times), and can potentially significantly increase the link margin. Other advantages include self-alignment of antenna beam for both the transmitting and receiving paths during field operation and possible pathways to full MIMO.

The schematics shown in FIGS. 3-7D are for illustration purposes only and should not limit the scope of this disclosure. In general, embodiments of the present invention provide a low-cost adapter that allows a Wi-Fi module to operate over the TVWS bands by ensuring that the transmitted TVWS signals meet the spectral mask and regulatory requirements for TVWS. In addition, by incorporating phase shifters, either digital or analog ones, the Wi-Fi over TVWS adapters can also provide beam steering functionality.

The foregoing descriptions of embodiments of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. An apparatus, comprising:
a first receiver coupled to a Wi-Fi module, wherein the first receiver is configured to receive a Wi-Fi signal from the Wi-Fi module;
an analog-to-digital conversion (ADC) module coupled to the first receiver, wherein the ADC module is configured to convert the received Wi-Fi signal to digital domain;
a spectral-shaping module configured to reshape a spectrum of the converted digital Wi-Fi signal;
a digital-to-analog conversion (DAC) module coupled to the spectral-shaping module; and
a first transmitter coupled to the DAC module, wherein the first transmitter is configured to transmit signals in TV white space (TVWS) bands.

2. The apparatus of claim 1, wherein the spectral-shaping module further includes at least a digital filter.

3. The apparatus of claim 2, wherein the digital filter is a finite impulse response (FIR) filter.

4. The apparatus of claim 2, wherein the spectral-shaping module further includes an upsampler.

5. The apparatus of claim 1, further comprising a sensor-and-switch module configured to:
determine whether the Wi-Fi module is transmitting signals; and
in response to determining that the Wi-Fi module is not transmitting signals, place the first receiver and the first transmitter in a sleep mode.

6. The apparatus of claim 1, further comprising:
a second receiver configured to receive signals in the TVWS bands; and
a second transmitter coupled to the second receiver, wherein the second transmitter is configured to transmit signals in Wi-Fi bands to the Wi-Fi module.

7. The apparatus of claim 5, further comprising an automatic gain control (AGC) module, wherein the AGC module is configured to adjust an operating mode of the second transmitter based on a level of a signal received by the second receiver.

8. The apparatus of claim 6, wherein the AGC module is configured to:
place the second transmitter in a low gain mode in response to the level of the signal received by the second receiver exceeding a predetermined threshold; and
place the second transmitter in a high gain mode in response to the level of the signal received by the second receiver being less than a predetermined threshold.

9. The apparatus of claim 5, wherein the AGC module is further configured to adjust an operating mode of the first transmitter based on a received signal strength indicator (RSSI) signal received from the Wi-Fi module.

10. The apparatus of claim 1, further comprising a phase shifter.

11. The apparatus of claim 10, wherein the phase shifter is an RF phase shifter configured to shift a phase of the received Wi-Fi signal, and wherein the phase shifter is positioned between the Wi-Fi module and the first receiver.

12. The apparatus of claim 10, wherein the phase shifter is a cross multiplier configured to shift a phase of a baseband signal, and wherein the phase shifter is positioned between the first receiver and the first transmitter.

13. The apparatus of claim 12, wherein the cross multiplier is a digital cross multiplier positioned between the ADC module and the DAC module.

14. A TV white space (TVWS) device, comprising:
a Wi-Fi module; and
an adapter coupled to the Wi-Fi module, the adapter comprising:
a first receiver coupled to and configured to receive a Wi-Fi signal from the Wi-Fi module;
an analog-to-digital conversion (ADC) module coupled to the first receiver and configured to convert the received Wi-Fi signal to digital domain;
a spectral-shaping module configured to reshape a spectrum of the converted digital Wi-Fi signal;
a digital-to-analog conversion (DAC) module coupled to the spectral-shaping module; and
a first transmitter coupled to the DAC module and configured to transmit signals in TVWS bands over an antenna.

15. The TVWS device of claim 14, wherein the spectral-shaping module further includes at least a finite impulse response (FIR) filter and an upsampler.

16. The TVWS device of claim 14, wherein the adapter further comprises a second receiver configured to receive signals in the TVWS bands from the antenna; and
a second transmitter coupled to the second receiver, wherein the second transmitter is configured to transmit signals in Wi-Fi bands to the Wi-Fi module.

17. The TVWS device of claim 16, wherein the adapter further comprises an automatic gain control (AGC) module.

18. The TVWS device of claim 14, further comprising additional adapters coupled to additional antennas to facilitate beam forming.

19. The TVWS device of claim 18, wherein a respective adapter further comprises a phase shifter.

20. The TVWS device of claim 19, wherein the phase shifter is an RF phase shifter configured to shift a phase of the received Wi-Fi signal, and wherein the phase shifter is positioned between the Wi-Fi module and the first receiver.

21. The TVWS device of claim 19, wherein the phase shifter is a cross multiplier configured to shift a phase of a baseband signal, and wherein the phase shifter is positioned between the first receiver and the first transmitter.
